(19) United States
(12) Patent Application Publication
(10) Pub. No.: US 2008/0291211 A1
(43) Pub. Date: Nov. 27, 2008

(54) PIXEL DATA TRANSFER CONTROLLER AND PIXEL DATA TRANSFER CONTROL METHOD

(75) Inventor: Toyoaki KUWAHARA, Suwa-shi (JP)

Correspondence Address: SUGHRUE-265550, 2100 PENNSYLVANIA AVE. NW, WASHINGTON, DC, 20037-3213, US

(73) Assignee: SEIKO EPSON CORPORATION, Tokyo (JP)

(21) Appl. No.: 12/029,499

(22) Filed: Feb. 12, 2008

(30) Foreign Application Priority Data
Feb. 14, 2007 (JP) 2007-033276

(51) Int. Cl. G09G 5/36

(52) U.S. Cl. 345/560

(57) ABSTRACT

A pixel data transfer controller reads color pixel data including pixel data pertaining to “m” color elements from a memory through a first bus having an “n”-byte width, and transfers the color pixel data to an image processing circuit through second buses which are associated with the respective color elements. The pixel data transfer controller includes: a buffer row, including buffers equivalent in number to a common multiple of “m” and “n”, each of the buffers having storage capacity for storing the pixel data pertaining to one of the color elements; a first selector, configured to sequentially store the pixel data of the color pixel data transferred through the first bus into the respective buffers of the buffer row for each color element; and a second selector, configured to output, to the second buses associated with respective color elements, the pixel data from groups of the buffers, each of the groups storing the pixel data pertaining to one of the color elements.

### BACKGROUND

1. Technical Field

The present invention relates to a technique for controlling transfer of pixel data by means of DMA (Direct Memory Access) transfer method.

2. Related Art

A multifunction machine including, for example, a copier, a scanner, a printer, a facsimile, and the like, has been known as a related-art image processing apparatus that generates pixel data (e.g., RGB data) by utilization of a scanning function. For instance, pixel data generated by the image processing apparatus include RGB data. In relation to RGB data, red (R) data, green (G) data, and blue (B) data are included in one pixel. In many cases, the size of each set of color data is eight bits. In that case, data size of one pixel comes to 24 bits.

In the previously-described image processing apparatus, RGB data generated in memory are usually transferred to an image processing circuit that subjects RGB data to various processing. Transfer operation performed herein is often carried out by means of the DMA transfer method or the like. RGB data are transferred in units of, for example, 32 bits or 64 bits. For instance, JP-A-2000-322375 describes a system that transfers data by means of the DMA transfer method.

At this time, RGB data are desired to be input to the image processing circuit on a per-pixel basis. However, as mentioned above, RGB data are transferred in units of 32 bits or 64 bits under the DMA transfer method, and hence the RGB data cannot be input to the image processing circuit on a per-pixel (24 bits) basis. For this reason, the RGB data transferred under the DMA transfer method are input to the image processing circuit by way of a bridge circuit capable of synchronously producing an output on a per-pixel basis. The bridge circuit includes at least a plurality of buffers; an input data selector for sequentially storing respective sets of color data transferred under the DMA transfer method into the respective buffers; and an output data selector for synchronously outputting sets of color data stored in each of the buffers, the data being equivalent to one pixel, to the image processing circuit. The output data selector must include a red data output selector for outputting only red (R) data; a green data output selector for outputting only green (G) data; and a blue data output selector for outputting only blue (B) data.

However, in the foregoing bridge circuit, the types of colors of color data stored in the respective buffers are indefinite. Hence, in order to cause output data selectors corresponding to respective colors to output color data in a predetermined color, the scale of a logic circuit constituting the output data selector must become great.

### SUMMARY

An advantage of some aspects of the invention is to provide a technique for enabling a reduction in the scale of a logic circuit constituting an output data selector.

According to an aspect of the invention, there is provided a pixel data transfer controller, operable to read color pixel data including pixel data pertaining to “m” color elements from a memory through a first bus having an “n”-byte width, and operable to transfer the color pixel data to an image processing circuit through second buses which are associated with the respective color elements, the pixel data transfer controller comprising:

a buffer row, including buffers equivalent in number to a common multiple of “m” and “n”, each of the buffers having storage capacity for storing the pixel data pertaining to one of the color elements;

a first selector, configured to sequentially store the pixel data of the color pixel data transferred through the first bus into the respective buffers of the buffer row for each color element; and

a second selector, configured to output, to the second buses associated with respective color elements, the pixel data from groups of the buffers, each of the groups storing the pixel data pertaining to one of the color elements.

The present disclosure relates to the subject matter contained in Japanese patent application No. 2007-033276 filed on Feb. 14, 2007, which is expressly incorporated herein by reference in its entirety.

### BRIEF DESCRIPTION OF THE DRAWINGS

The invention will be described with reference to the accompanying drawings, wherein like numbers reference like elements.

FIG. 1 is a hardware schematic diagram of a pixel data transfer controller of an embodiment of the present invention.

FIG. 2 is a block diagram showing an example configuration of the pixel data transfer control system of the embodiment of the present invention.

FIG. 3 is a descriptive view conceptually showing a data structure of pixel data stored in a main memory.

FIG. 4 is a flowchart for describing storage processing performed by the pixel data transfer controller.

FIG. 5 is a flowchart for describing output processing performed by the pixel data transfer controller.

### DESCRIPTION OF EXEMPLARY EMBODIMENTS

The exemplary embodiments for practicing the present invention will be described hereunder by reference to the drawings.

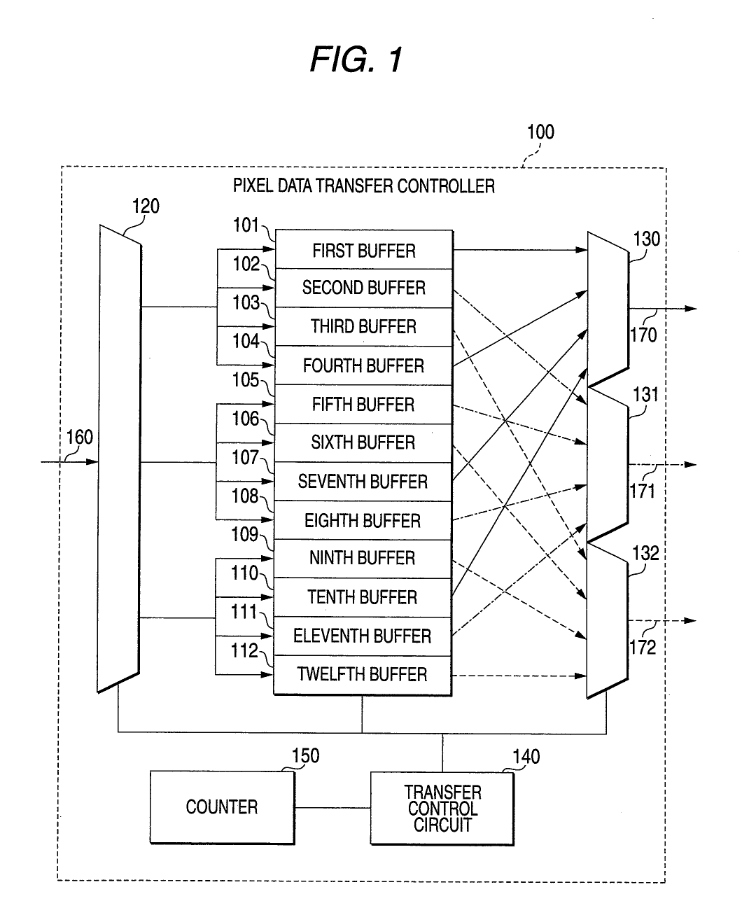

A block diagram of FIG. 1 shows an example hardware configuration of a pixel data transfer controller 100 applied to the embodiment of the present invention. As illustrated, the pixel data transfer controller 100 includes buffers (101 to 112) for storing RGB data; an input data selector 120; output data selectors (130 to 132); a transfer control circuit 140; and a counter 150.

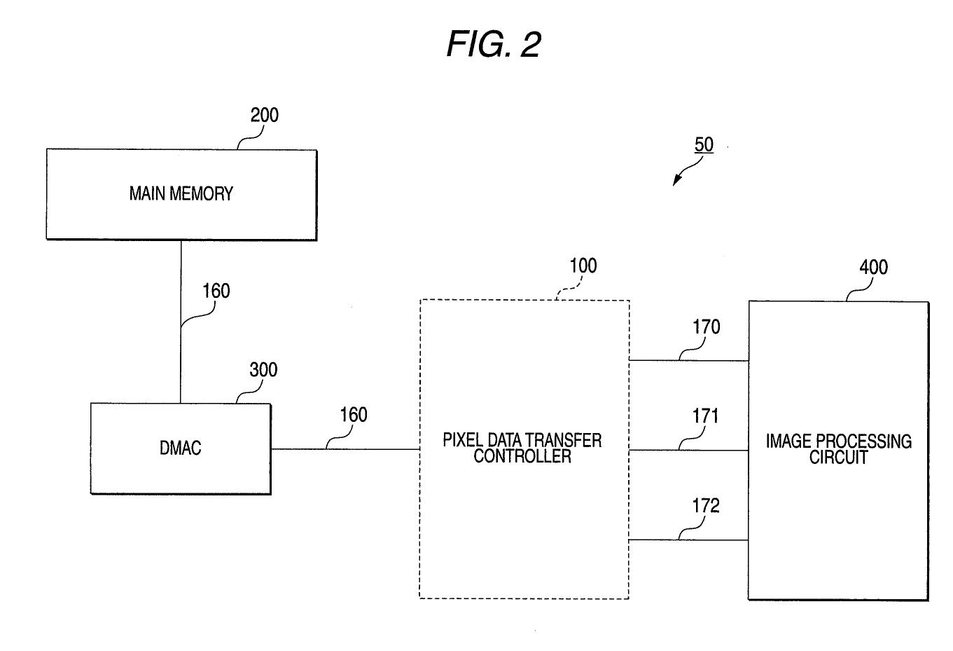

The image data transfer controller 100 is used in, for example, a pixel data transfer control system 50 such as that shown in FIG. 2. As illustrated, the pixel data transfer control system 50 includes the pixel data transfer controller 100, a main memory 200, a DMAC (Direct Memory Access Controller) 300, and an image processing circuit 400. In the pixel data transfer control system 50, RGB data stored in the main memory 200 are transferred to the pixel data transfer controller 100 by means of a DMA transfer method by way of an input bus 160 having a 32-bit width. The pixel data transfer controller 100 synchronizes the RGB data transferred from the main memory 200 on a per-pixel basis and transfers the data to the image processing circuit 400 by way of an output bus (170, 171, or 172). As a result, in addition to ascertaining the data equivalent to one pixel synchronously transferred from the pixel data transfer controller 100, the image processing circuit 400 can subject the data to image processing.

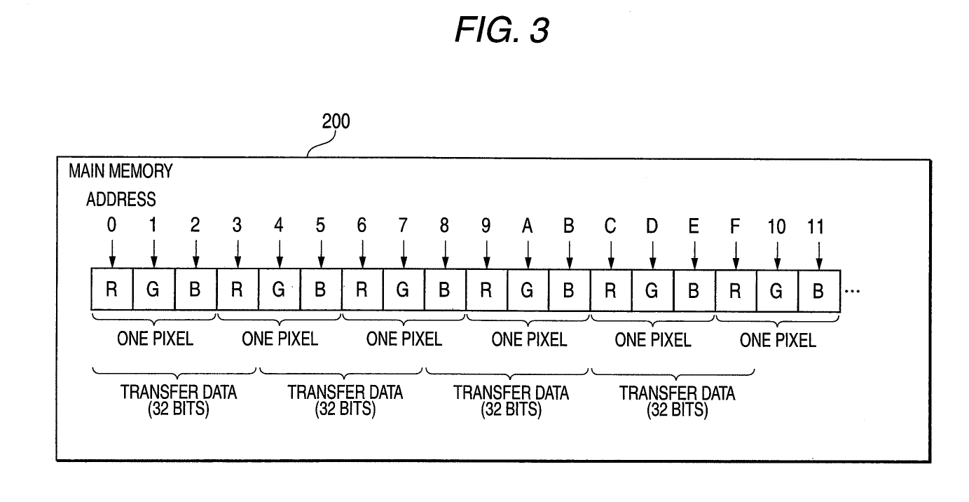

The main memory 200 is, for example, a memory that generates RGB data by utilization of a scanning function and that is incorporated in a multifunction machine including a copier, a scanner, a printer, a facsimile, and the like. As shown in FIG. 3, data in respective colors [red (R) data, green (G) data, and blue (B) data] of the generated RGB data are stored in the main memory 200 in sequence of an address. The size of each set of color data is eight bits (one byte), and color data in three colors form one pixel of RGB data. Therefore, a data size of RGB data equivalent to one pixel comes to 24 bits.

Turning back to FIG. 2, the DMAC 300 is a custom-designed LSI that controls data transfer conforming to the DMA transfer method (transfer of data from the main memory 200 to the pixel data transfer controller 100) by means of which data are transferred without involvement of a CPU. Data transfer conforming to the DMA transfer method is performed at a 32-bit bus width by way of the input bus 160.

The image processing circuit 400 is a circuit that subjects RGB data transferred from the pixel data transfer controller 100 to various types of image processing. Herein, various types of image processing include processing such as “binarization processing,” “edge detection processing,” “correction processing,” and the like. Moreover, data in respective colors [red (R) data, green (G) data, and blue (B) data] forming one pixel of RGB data are synchronously input to the image processing circuit 400. Transfer of data in respective colors (input of data in respective colors into the image processing circuit 400) is performed by use of buses specifically provided for respective colors. For instance, red (R) data are synchronously input to the image processing circuit 400 by way of a red-data-specific bus 170; green (G) data are synchronously input to the same by way of a green-data-specific bus 171; and blue (B) data are synchronously input to the same by way of a blue-data-specific bus 172.

Turning back to FIG. 1, buffers (101 to 112) of the pixel data transfer controller 100 are for storing the RGB data transferred from the main memory 200. The buffers (101 to 112) include 12 buffers; namely, a first buffer 101, a second buffer 102, a third buffer 103, a fourth buffer 104, a fifth buffer 105, a sixth buffer 106, a seventh buffer 107, an eighth buffer 108, a ninth buffer 109, a tenth buffer 110, an eleventh buffer 111, and a twelfth buffer 112. In the present embodiment, the number of buffers (101 to 112) is taken as 12, but the number is determined in such a way that a common multiple of [a bus width {four bytes (32 bits)} for data transfer conforming to the DMA transfer method]×[the number of colors (three colors) of color data] is achieved. Further, each of the buffers (101 to 112) has data storage capacity for storing one piece of color data [one byte (eight bits)]. The RGB data input by way of the input selector 120 are stored in the respective buffers (101 to 112) in sequence of transferred color data. For instance, when the RGB data are transferred from the main memory 200 in sequence of red data (R1), green data (G1), blue data (B1), and red data (R2), the red data (R1) are stored in the first buffer 101; the green data (G1) are stored in the second buffer 102; the blue data (B1) are stored in the third buffer 103; and the red data (R2) are stored in the fourth buffer 104 in sequence. When blue data (B4) are stored in the twelfth buffer 112, the subsequently-transferred red data (R5) are stored in the first buffer 101. As mentioned above, as a result of the number of buffers (101 to 112) being set to 12, the red (R) data are stored in the first buffer 101, the fourth buffer 104, the seventh buffer 107, and the tenth buffer 110. The green (G) data are stored in the second buffer 102, the fifth buffer 105, the eighth buffer 108, and the eleventh buffer 111. Moreover, the blue (B) data are stored in the third buffer 103, the sixth buffer 106, the ninth buffer 109, and the twelfth buffer 112. Further, the respective buffers (101 to 112) are connected to the output data selectors (130 to 132), and the stored color data are output to the output data selectors (130 to 132).

The input data selector 120 is a circuit that determines the buffers (101 to 112) where the respective sets of color data are to be stored in such a way that the RGB data transferred from the main memory 200 by means of the DMA transfer method in units of 32 bits can be sequentially stored in the respective buffers (101 to 112) for each set of color data.

The output data selectors (130 to 132) are circuitry that synchronizes sets of color data [red (R) data, green (G) data, and blue (B) data] constituting one pixel in sequence of color data previously stored in the buffers (101 to 112) among the sets of color data stored in the respective buffers (101 to 112) and that outputs the thus-synchronized data to the image processing circuit 400. For instance, the output data selectors (130 to 132) include the selector 130 specifically designed for outputting red data (hereinafter called a “red data output selector”), the selector 131 specifically designed for outputting green data (hereinafter called a “green data output selector”), and the selector 132 specifically designed for outputting blue data (hereinafter called a “blue data output selector”). The red data output selector 130 is circuitry that is connected to the first buffer 101, the fourth buffer 104, the seventh buffer 107, and the tenth buffer 110 and that outputs red data to the image processing circuit 400 by way of the red-data-specific bus 170. The green data output selector 131 is circuitry that is connected to the second buffer 102, the fifth buffer 105, the eighth buffer 108, and the eleventh buffer 111 and that outputs green data to the image processing circuit 400 by way of the green-data-specific bus 172. Moreover, the blue data output selector 132 is circuitry that is connected to the third buffer 103, the sixth buffer 106, the ninth buffer 109, and the twelfth buffer 112 and that outputs blue data to the image processing circuit 400 by way of the blue-data-specific bus 172.

The transfer control circuit 140 is a circuit that controls the input data selector 120, the respective buffers (101 to 112), and the output data selector 130, to thus output the RGB data transferred from the main memory 200 to the image processing circuit 400 by means of synchronizing respective sets of color data forming one pixel. For instance, the transfer control circuit 140 is connected to a counter 150. The transfer control circuit 140 cause the counter 150 to count the number of buffers (101 to 112) where no RGB data are stored and the number of sets of RGB data output from the buffers (101 to 112). As a result, the transfer control circuit 140 can control the input data selector 120 so as to store RGB data (four sets of color data) equivalent to 32 bits into the buffers (101 to 112) when the buffers (101 to 112) where no RGB data are stored are four or more. Moreover, when three or more sets of RGB data are stored in the buffers (101 to 112), the transfer control circuit 140 can output respective sets of color data; that is, red data, green data, and blue data, to the red data output selector 130, the green data output selector 131, and the blue data output selector 132, respectively.

The counter 150 includes a counter for counting the number of times RGB data equivalent to 32 bits are stored in the respective buffers (101 to 112) and a counter for counting the number of times the RGB data stored in the respective buffers (101 to 112) are output on a per-pixel basis. The counter 150 is connected to the transfer control circuit 140 and can increment, decrement, reset, or the like, a count value in response to a request from the transfer control circuit 140.

By means of the configuration, the pixel data transfer controller 100 can transfer the RGB data transferred from the main memory 200 to the image processing circuit 400 by means of synchronizing respective sets of color data constituting one pixel by way of an output bus (170, 171, or 172).

The pixel data transfer controller 100 of the present embodiment is compared with a related-art data transfer device. As mentioned previously, the related-art data transfer device is indefinite in terms of the types of colors of color data stored in respective buffers. The reason for this is that the number of buffers provided in the data transfer device does not come to a common multiple of [a bus width {four bytes (32 bits)} for data transfer conforming to the DMA transfer method]×[the number of colors (three colors) of color data]. For this reason, there is no alternative way but to set a ratio of (an input:an output) to (the number of buffers: 1) in relation to the output data selector that performs control so as to cause the respective buffers to synchronize and output respective sets of color data constituting one pixel. However, in the pixel data transfer controller 100 of the present embodiment, the number of buffers (101 to 112) provided in the pixel data transfer controller 100 comes to a common multiple of [a bus width {four bytes (32 bits)} for data transfer conforming to the DMA transfer method]×[the number of colors (three colors) of color data]. Therefore, color data stored in one of the buffers (101 to 112) are inevitably data in the same color. Therefore, the output data selectors (130 to 132) that perform control so as to cause the respective buffers (101 to 112) to synchronize and output respective sets of color data constituting one pixel are set in such a way that a ratio of (an input:an output) comes to [{(the number of buffers×⅓):1}]. This means that the logic depth of the output data selectors (130 to 132) becomes shallow when compared with that achieved in the related art (i.e., the circuit scale becomes smaller), so that transfer of RGB data becomes faster.

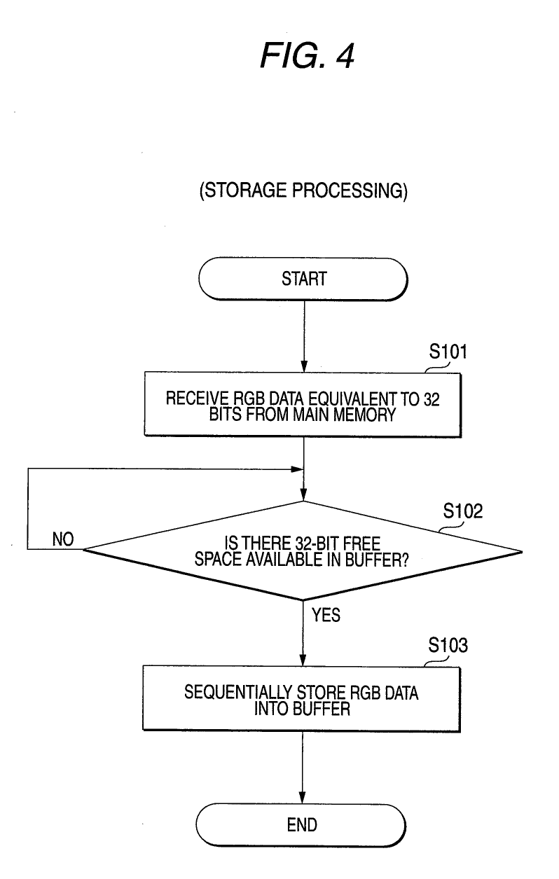

FIG. 4 is a flowchart showing storage of RGB data performed by the pixel data transfer controller 100.

The transfer control circuit 140 of the pixel data transfer controller 100 starts storage processing when RGB data are transferred to the input data selector 120. For instance, the transfer control circuit 140 starts storage processing when a signal showing that RGB data have been transferred to the input data selector 120 is supplied from the input data selector 120.

When the transfer control circuit 140 starts storage processing, the input data selector 120 receives RGB data equivalent to 32 bits (step S101).

At this time, the transfer control circuit 140 acquires data pertaining to the number of buffers (101 to 112) where no RGB data are stored and determines whether or not free space equivalent to 32 bits is available (step S102). Specifically, the transfer control circuit 140 makes an access to the counter 150, thereby acquiring a signal showing the number of times RGB data (equivalent to 32 bits) are input to the buffers (101 to 112) (hereinafter called an “input count value”) and a signal showing the number of times RGB data (equivalent to one pixel) are output to the buffers (110 to 112) (hereinafter called an “output count value”). The transfer control circuit 140 computes (an output count value×3)−(an input count value×4), thereby determining whether or not a result of computation is four or more.

When determined, in step S102, that the free space equivalent to 32 bits is not available (No in step S102), the transfer control circuit 140 waits until free space equivalent to 32 bits becomes available in the buffers (101 to 112).

When determined, in step S102, that free space equivalent to 32 bits is available (Yes in step S102), the transfer control circuit 140 controls the input data selector 120, to thus sequentially store RGB data equivalent to 32 bits into the buffers (101 to 112) (step S103). Specifically, the transfer control circuit 140 stores color data equivalent to 32 bits (four sets) of color data into the buffers (101 to 112) in sequence from the color data transferred to the input data selector 120. For instance, RGB data are not stored in the sixth buffer 106 to the tenth buffer 110, the transfer control circuit 140 controls the input data selector 120 so as to store the color data equivalent to 32 bits (four sets) of color data into the sixth buffer 106, the seventh buffer 107, the eighth buffer 108, and the ninth buffer 109 in sequence of the color data having been transferred to the input data selector 120. Moreover, for example, when RGB data are not stored in the first buffer 101 to the third buffer 103 and the tenth buffer 110 to the twelfth buffer 112, the transfer control circuit 140 controls the input data selector 120 so as to store 32 bits (four sets) of color data into the tenth buffer 110, the eleventh buffer 111, the twelfth buffer 112, and the first buffer 101.

After storing the RGB data equivalent to 32 bits into the buffers (101 to 112), the transfer control circuit 140 increments an input count value of the counter 150, and storage processing is completed.

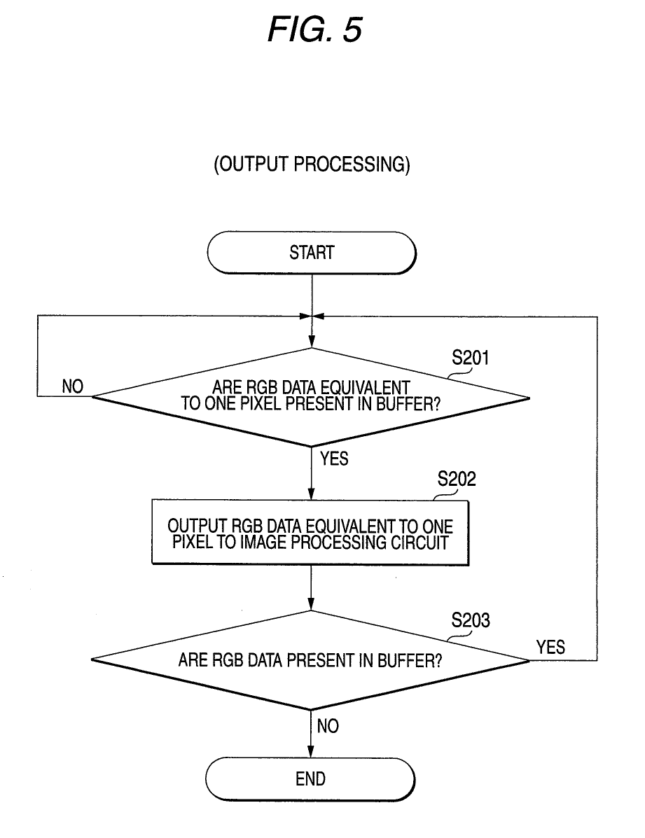

FIG. 5 is a flowchart showing output of RGB data performed by the pixel data transfer controller 100.

When power is supplied from an unillustrated power source to the pixel data transfer controller 100, the transfer control circuit 140 of the pixel data transfer controller 100 commences output processing.

First, the transfer control circuit 140 determines whether or not the RGB data equivalent to one pixel are stored in the buffers (101 to 112) (step S201). Specifically, the transfer control circuit 140 makes an access to the counter 150, thereby acquiring a signal showing the number of times RGB data (equivalent to 32 bits) are input to the buffers (101 to 112) (hereinafter called an “input count value”) and a signal showing the number of times RGB data (equivalent to one pixel) are output to the buffers (101 to 112) (hereinafter called an “output count value”). The transfer control circuit 140 computes (an input count value×4)−(an output count value×3), thereby determining whether or not a result of computation is three or more.

When determined, in step S201, that the RGB data equivalent to one pixel are not stored in the buffers (101 to 112) (No in step S201), the transfer control circuit 140 waits until RGB data equivalent to one pixel are stored in the buffers (101 to 112).

In the meantime, when determined, in step S201, that the RGB data equivalent to one pixel are stored in the buffers (101 to 112) (Yes in step S201), the transfer control circuit 140 controls the output data selectors (130 to 132), thereby outputting RGB data equivalent to one pixel to the image processing circuit 400 (step S202). Specifically, the transfer control circuit 140 outputs respective color data earliest stored in the buffers (101 to 112); namely, the red (R) data, the green (G) data, and the blue (B) data, to the red data output selector 130, the green data output selector 131, and the blue data output selector 132. For instance, when the red (R) data are stored in the fourth buffer 104 and the seventh buffer 107; when the green (G) data are stored in the fifth buffer 105; and when the blue (B) data are stored in the sixth buffer 106, the transfer control circuit 140 causes the red data output selector 130 to output the red (R) data stored in the fourth buffer 104 to the image processing circuit 400 by way of the red-data-specific bus 170. In synchronization with output of the red data, the transfer control circuit 140 causes the green data output selector 131 to output the green (G) data stored in the fifth buffer 105 to the image processing circuit 400 by way of the green-data-specific bus 171. In synchronization with output of the green data, the transfer control circuit 140 causes the blue data output selector 132 to output the blue (B) data stored in the sixth buffer 106 to the image processing circuit 400 by way of the blue-data-specific bus 172.

At this time, the transfer control circuit 140 has deleted the data still remaining in the buffers (101 to 112) from which the RGB data have been output.

After the RGB data equivalent to one pixel are output to the image processing circuit 400 in step S202, the transfer control circuit 140 increments the output count value of the counter 150, thereby causing processing to proceed to step S203.

In step S203, the transfer control circuit 140 determines whether or not the RGB data are stored in the buffers (101 to 112) (step S203). Specifically, the transfer control circuit 140 makes an access to the counter 150, thereby acquiring a signal showing the number of times RGB data (equivalent to 32 bits) are input to the buffers (101 to 112) (an input count value) and a signal showing the number of times RGB data (equivalent to one pixel) are output to the buffers (110 to 112) (an output count value). The transfer control circuit 140 computers (an output count value×3)−(an input count value×4), thereby determining whether or not a result of computation is zero.

When determined, in step S203, that the RGB data are stored in the buffers (101 to 112) (Yes in step S203), the transfer control circuit 140 causes processing to proceed to step S201. In the meantime, when determined that the RGB data are not stored in the buffers (101 to 112) (No in step S203), the transfer control circuit 140 terminates output processing.

The present invention is not limited to the embodiment and susceptible to various modifications and applications.

For example, in the above embodiment, the transfer control circuit 140 controls the input data selector 120, the respective buffers (101 to 112), and the output data selectors (130 to 132), thereby synchronizing respective sets of color data constituting RGB data and outputting the thus-synchronized data to the image processing circuit 400. However, the present invention is not limited to such a configuration. For instance, a storage device storing a predetermined program, a CPU for processing the program, and the like, may be provided, and a CPU may be caused to process the program, thereby controlling transfer of RGB data.

In the embodiment, a bus width for data transfer conforming to the DMA transfer method is set to 32 bits. However, the present invention is not limited to the bit width, and RGB data may also be transferred by means of a 64-bit bus width or a 128-bit bus width.

In the embodiment, the number of buffers (101 to 112) of the pixel data transfer controller 100 is set to 12. However, the present invention is not limited to that number. Any number may also be adopted, so long as the number fulfills a common multiple of [a bus width (bytes) for data transfer conforming to the DMA transfer method]×[the number of types of color data]. However, each set of color data (one byte) can be stored in one buffer (101 to 112).

In the embodiment, the pixel data transfer controller 100 is assumed to control transfer of pixel data having color data in three colors; namely, RGB data. However, the present invention is not limited to transfer of RGB data. Pixel data to be transferred may also include color data of types which are larger or smaller than three colors.

Moreover, the present embodiment has described the case where the pixel data transfer controller 100 is applied to the pixel data transfer control system 50 shown in FIG. 2, thereby controlling transfer of pixel data from the main memory 200 to the image processing circuit 400. However, the present invention is not limited to the case and may also be arranged so as to cause the pixel data transfer controller 100 to control transfer of pixel data even when the pixel data having undergone image processing in the image processing circuit 400 are transferred to the main memory 200. In this case, for instance, the image processing circuit 400 inputs respective sets of color data [red (R) data, green (G) data, and blue (B) data]; i.e., RGB data, having undergone image processing to the pixel data transfer controller 100 by way of the red-data-specific bus 170, the green-data-specific bus 171, and the blue-data-specific bus 172. At this time, the pixel data transfer controller 100 sequentially stores the pixel data into the first buffer 101 to the twelfth buffer 112 by way of reversely-oriented selectors corresponding to the red data output selector 130, the green data output selector 131, and the blue data output selector 132. In this case, the red data are sequentially stored in the first buffer 101, the fourth buffer 104, the seventh buffer 107, and the tenth buffer 110. The green data are sequentially stored in the second buffer 102, the fifth buffer 105, the eighth buffer 108, and the eleventh buffer 111. Moreover, the blue data are sequentially stored in the third buffer 103, the sixth buffer 106, the ninth buffer 109, and the twelfth buffer 112. The pixel data transfer controller 100 sequentially transfers to the main memory 200 in units of 32 bits the pixel data stored in the first buffer 101 to the twelfth buffer 112 by way of a reversely-oriented selector corresponding to the input data selector 120. As a result, transfer of pixel data from the image processing circuit 400 to the main memory 200 can be implemented by means of the configuration analogous to that shown in FIG. 1.

According to an aspect of the present invention, the scale of a logic circuit constituting an output data selector can be made smaller.

What is claimed is:

1. A pixel data transfer controller, operable to read color pixel data including pixel data pertaining to “m” color elements from a memory through a first bus having an “n”-byte width, and operable to transfer the color pixel data to an image processing circuit through second buses which are associated with the respective color elements, the pixel data transfer controller comprising:
a buffer row, including buffers equivalent in number to a common multiple of “m” and “n”, each of the buffers having storage capacity for storing the pixel data pertaining to one of the color elements;
a first selector, configured to sequentially store the pixel data of the color pixel data transferred through the first bus into the respective buffers of the buffer row for each color element; and
a second selector, configured to output, to the second buses associated with respective color elements, the pixel data from groups of the buffers, each of the groups storing the pixel data pertaining to one of the color elements.

2. The pixel data transfer controller according to claim 1, wherein
the first selector reads from the memory the pixel data in sequence previously set for the color elements and sequentially stores the pixel data into the respective buffers of the buffer row for each color element.

3. The pixel data transfer controller according to claim 1, wherein
the “m” color elements include red, green, and blue.

4. The pixel data transfer controller according to claim 1, wherein
the storage capacity of each of the buffers is one byte.

5. A method of controlling pixel data transfer in a pixel data transfer controller, the pixel data transfer controller, operable to read color pixel data including pixel data pertaining to “m” color elements from a memory through a first bus having an “n”-byte width, and operable to transfer the color pixel data to an image processing circuit through second buses which are associated with the respective color elements, the pixel data transfer controller including: a buffer row, including buffers equivalent in number to a common multiple of “m” and “n”, each of the buffers having storage capacity for storing the pixel data pertaining to one of the color elements; a first selector; and a second selector, the method comprising:
sequentially storing the pixel data of the color pixel data transferred through the first bus into the respective buffers of the buffer row for each color element by the first selector; and
outputting, to the second buses associated with respective color elements, the pixel data from groups of the buffers, each of the groups storing the pixel data pertaining to one of the color elements, by the second selector.

6. The method according to claim 5, wherein
in the storing process, the first selector reads from the memory the pixel data in sequence previously set for the color elements and sequentially stores the pixel data into the respective buffers of the buffer row for each color element.

7. The method according to claim 5, wherein
the “m” color elements include red, green, and blue.

8. The method according to claims 5, wherein
the storage capacity of each of the buffers is one byte.
